(19) United States
(12) Patent Application Publication
(10) Pub. No.: US 2017/0178330 A1
(43) Pub. Date: Jun. 22, 2017

(54) SYSTEM AND METHOD FOR INTERIOR MOBILE MAPPING

(71) Applicant: INSTITUTE FOR INFORMATION INDUSTRY, Taipei (TW)

(72) Inventors: Chih-Hung LI, New Taipei City (TW); Kai-Wei CHIANG, Tainan City (TW); Chien-Hsun CHU, Hsinchu City (TW); Chen-Kai LIAO, Tainan City (TW); Guang-Je TSAI, Pingtung County (TW)

(21) Appl. No.: 14/972,098

(22) Filed: Dec. 17, 2015

(51) Int. Cl. G06T 7/00

(52) U.S. Cl. CPC G06T 7/0044

(57) ABSTRACT

The present invention discloses an interior mobile mapping system and method thereof. The interior mobile mapping method comprises the following steps: establishing a plurality of interior reference points; obtaining coordinates of the plurality of interior reference points corresponded to an interior coordinate system; moving from one interior reference point which is closest to an interior object; taking a picture for the interior object at more than two different places individually; and calculating the coordinate of the interior object corresponded to an exterior coordinate system according to the respective position of the interior object in the pictures and the coordinates of the different shooting locations.

### BACKGROUND

Field of Invention

The present invention relates to a system and method for interior mobile mapping. More particularly, the present invention relates to a system and method for interior mobile mapping, which merges an exterior coordinate system with an interior coordinate system and incorporate an old maps into a new map seamlessly.

Description of Related Art

In conventional technology, an interior mapping method uses high-accuracy inertial measurement unit. An initialization is from an outdoor space to an indoor space or starting from a reference point in an operating process. The operating process uses a zero velocity update mechanism to keep the accuracy. However, due to a large working area and long time, the accuracy will decrease continually and not identical in each area. In additions, a lot of data to be processed will also cause operation time consuming.

For traditional measurement mode, an interior mapping system is an independent coordinate system, which is not able to merge with an exterior coordinate system directly so as to the back-end systems will be operated individually. Namely, the exterior coordinate system uses one type of software, and the interior coordinate system uses another type. In addition, updating the area has been established is not executed directly if the existing old map has a different coordinate system from the interior coordinate system. In existing technology, for incorporating the existing old map, all information of the existing old map must be calculated to transfer and adjust parameters so as to cause a long-time and complex operation.

### SUMMARY

The invention provides a system and method for interior mobile mapping, which is adapted for an exterior coordinate system outside directly. The system also can incorporate an old map so as to have wide applications. In addition, the system and method for interior mobile mapping of the present invention makes each space of an inspected area has an identical accuracy and improves the updating efficiency.

An aspect of the disclosure is to provide an interior mobile mapping system, which is adapted for producing or updating an interior layout of an inspected area. The interior mobile mapping system includes an inertial measurement unit, a digital camera module and a control device. The control device is coupled to the inertial measurement unit and the digital camera module, wherein the control device establishes at least two interior reference points through the inertial measurement unit and obtains the respective coordinate of the at least two interior reference points corresponded to an interior coordinate system, the control device moves from one interior reference point which is the closest interior reference point corresponding to an update object, a running trace of the inertial measurement unit in the inspected area is feedback positioned by the control device according to the coordinate of the at least one interior reference points, the control device uses the digital camera module to take one picture for the update object at more than two different places individually, the coordinate of the update object corresponded to the interior coordinate system is calculated by the control device according to the respective position of the update object in the more than two pictures and the coordinate of the more than two shooting locations corresponded to the interior coordinate system, so as to update the interior layout.

In one embodiment of the present invention, the control device calculates the coordinate of the update object corresponded to an exterior coordinate system according to the coordinate of the update object corresponded to the interior coordinate system and the coordinate of the interior reference point closest to the update object corresponded to the interior coordinate system, wherein the control device uses the at least two interior reference points which have respective coordinate corresponded the exterior coordinate system to establish the interior coordinate system.

In one embodiment of the present invention, the interior mobile mapping system further comprises an starting point is chosen at exterior area and the coordinate of the starting point corresponded an exterior coordinate system is obtained when a mapping process of the inspected area operated at first time and no old map corresponded to the inspected area are determined, wherein the control device moves from the starting point and uses the inertial measurement unit to establish at least two interior reference points in the inspected area, and the control device uses the at least two interior reference points which have respective coordinate corresponded the exterior coordinate system to establish the interior coordinate system.

In one embodiment of the present invention, the interior mobile mapping system further comprises an old map is digitized when a mapping process of the inspected area operated at first time and having the old map corresponded to the inspected area are determined, wherein an starting point is chosen at exterior area and the coordinate of the starting point corresponded an exterior coordinate system is obtained, the control device moves from the starting point and uses inertial measurement unit to establish at least two interior reference points, and the control device uses the at least two interior reference points which have respective coordinate corresponded the exterior coordinate system to establish the interior coordinate system and transfers coordinate parameters of the old map to new coordinates which are in accordance with the interior coordinate system.

In one embodiment of the present invention, the control device moves from one interior reference point which is the closest interior reference point corresponding to an interest object, wherein a running trace of the inertial measurement unit in the inspected area is feedback positioned by the control device according to the coordinate of the at least one interior reference points, the control device uses the digital camera module to take one picture for the interest object at more than two different places individually, the coordinate of the interest object corresponded to the interior coordinate system is calculated by the control device according to the respective position of the interest object in the more than two pictures and the coordinate of the more than two shooting locations corresponded to the interior coordinate system, so as to produce the interior layout, the control device calculates the coordinate of the interest object corresponded to the exterior coordinate system according to the coordinate of the interest object corresponded to the interior coordinate system and the coordinate of the interior reference point closest to the interest object corresponded to the interior coordinate system.

In one embodiment of the present invention, the interior mobile mapping system further comprises two optical transmitter modules. The two optical transmitter modules are coupled to the control device and emit one beam individually to the ground vertically, wherein the two optical transmitter modules emit one beam individually to the two sides of each interior reference point in order to obtain two alignment points when the inertial measurement unit establishes at least two interior reference points, the two optical transmitter modules emit one beam individually to align the two alignment points when the control device moves from one interior reference point that is the closest interior reference point corresponded to the interest object, so as to check a position and an orientation of the interior mobile mapping system.

Another aspect of the disclosure is to provide an interior mobile mapping method is adapted for producing or updating an interior layout of an inspected area. The interior mobile mapping method comprises the following steps: obtaining the respective coordinate of the at least two interior reference points corresponded to an interior coordinate system, wherein the at least two interior reference are established by an inertial measurement unit; moving from one interior reference point which is the closest interior reference point corresponding to an update object, wherein a running trace of the inertial measurement unit in the inspected area is feedback positioned according to the coordinate of the at least one interior reference points; taking one picture for the update object at more than two different places individually; and calculating the coordinate of the update object corresponded to the interior coordinate system according to the respective position of the update object in the more than two pictures and the coordinate of the more than two shooting locations corresponded to the interior coordinate system, so as to update the interior layout.

In one embodiment of the present invention, the interior mobile mapping method further comprises the following steps: calculating the coordinate of the update object corresponded to an exterior coordinate system according to the coordinate of the update object corresponded to the interior coordinate system and the coordinate of the interior reference point closest to the update object corresponded to the interior coordinate system, wherein the interior coordinate system is established by the at least two interior reference points which have respective coordinate corresponded the exterior coordinate system.

In one embodiment of the present invention, the interior mobile mapping method further comprises the following steps: choosing an starting point at exterior area and obtaining the coordinate of the starting point corresponded an exterior coordinate system when a mapping process of the inspected area operated at first time and no old map corresponded to the inspected area are determined; moving from the starting point and using the inertial measurement unit to establish at least two interior reference points in the inspected area; and using the at least two interior reference points which have respective coordinate corresponded the exterior coordinate system to establish the interior coordinate system.

In one embodiment of the present invention, the interior mobile mapping method further comprises the following steps: digitizing an old map when a mapping process of the inspected area operated at first time and having the old map corresponded to the inspected area are determined; choosing an starting point at exterior area and obtaining the coordinate of the starting point corresponded an exterior coordinate system; moving from the starting point and using the inertial measurement unit to establish at least two interior reference points in the inspected area; and using the at least two interior reference points which have respective coordinate corresponded the exterior coordinate system to establish the interior coordinate system and transferring coordinate parameters of the old map to new coordinates which are in accordance with the interior coordinate system.

In one embodiment of the present invention, the interior mobile mapping method further comprises the following steps: moving from one interior reference point which is the closest interior reference point corresponding to an interest object, wherein a running trace of the inertial measurement unit in the inspected area is feedback positioned according to the coordinate of the at least one interior reference points; taking one picture for the interest object at more than two different places individually; calculating the coordinate of the interest object corresponded to the interior coordinate system according to the respective position of the interest object in the more than two pictures and the coordinate of the more than two shooting locations corresponded to the interior coordinate system; and calculating the coordinate of the interest object corresponded to the exterior coordinate system according to the coordinate of the interest object corresponded to the interior coordinate system and the coordinate of the interior reference point closest to the interest object corresponded to the interior coordinate system.

In one embodiment of the present invention, the interior mobile mapping method further comprises the following steps: using two optical transmitter modules to emit one beam individually to the two sides of each interior reference point in order to obtain two alignment points when the inertial measurement unit establishes at least two interior reference points; and using the two optical transmitter modules to emit one beam individually to align the two alignment points when the control device moves from one interior reference point that is the closest interior reference point corresponded to the interest object, so as to check a position and an orientation of the interior mobile mapping system.

Another aspect of the disclosure is to provide an interior mobile mapping method. The interior mobile mapping method is implemented by a mobile image system, wherein the mobile image system includes an inertial measurement unit, an image capture unit and a control device, the mobile image system is adapted for producing an interior layout of an interior inspected area, the interior inspected area has an update object, the interior mobile mapping method comprises the following steps: (A) obtaining coordinates of at least two interior reference points corresponded to an exterior coordinate system, wherein the at least two interior reference points are established by the inertial measurement unit; (B) moving from the interior reference point which is closest to the update object, and a running trace of the mobile image system in the interior inspected area is feedback positioned according to the coordinates of each interior reference point by the inertial measurement unit; (C) taking one picture for the update object at more than two different places individually through the image capture unit; and (D) calculating a coordinate of the update object according to the respective position of the update object in the more than two pictures and coordinates of the more than two shooting locations, so as to update the interior layout.

An aspect of the disclosure is to provide an interior mobile mapping system, which is adapted for producing an interior layout of an inspected area. The interior mobile mapping system comprises an inertial measurement unit, a digital camera module, a control device, and at least two optical transmitter modules. The inertial measurement unit used to position a running trace of the interior mobile mapping system according to an acceleration of the interior mobile mapping system. The digital camera module used to shoot a peripheral image of the interior mobile mapping system. The control device coupled to the inertial measurement unit and the digital camera module, wherein the control device is used to calculate a coordinate of each point on the running trace according to an initial coordinate of an initial position, the control device calculates the coordinate of a real object according to the pictures which are focus on the real object and captured by the digital camera module at more than two shooting location on the running trace and coordinates of the more than two shooting locations, so as to update the interior layout. The at least two optical transmitter modules configured on the interior mobile mapping system and individually emit a beam to the ground vertically at an operational state in order to align at least two alignment points, so as to check a position and an orientation of the interior mobile mapping system at the initial position precisely.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of the interior mobile mapping system according to the first embodiment of the present invention;

FIG. 2 is a flowchart of the interior mobile mapping method according to the first embodiment of the present invention; and

FIG. 3A, FIG. 3B and FIG. 3C are operation schematic diagrams of the interior mobile mapping method according to the first embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The invention provides a system and method for interior mobile mapping, which is adapted for an exterior coordinate system outside directly. The system also can incorporate an old map so as to have wide applications. In addition, the system and method for interior mobile mapping of the present invention makes each space of an inspected area has an identical accuracy and improves the updating efficiency.

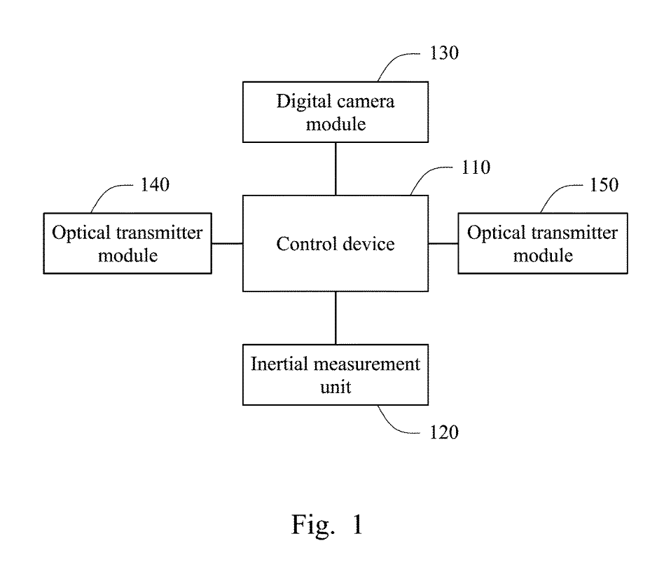

FIG. 1 is a block diagram of the interior mobile mapping system according to the first embodiment of the present invention. The interior mobile mapping system includes a control device 110, an inertial measurement unit 120, a digital camera module 130, and two optical transmitter modules 140 and 150. The control device 110 is coupled to the inertial measurement unit 120, digital camera module 130, and the two optical transmitter modules 140 and 150 individually. The interior mobile mapping system of the present invention is a combination of the above units. The structure of the interior mobile mapping system can be established on a trolley or an electric car, and users can push the trolley by themselves or uses motors to drive the electric car.

The control device 110 of the present invention can be a processor, a personal computer or an industrial computer system, which controls all the operations of the interior mobile mapping system. The inertial measurement unit 120 has a tri-axial gyroscope and tri-axial accelerometer to measure the angular velocity and the acceleration of an object in a three-dimension space and calculate the displacement of the object accurately. The function of the digital camera module 130 is shooting an interest object. According to the interest object's position in the picture and the inertial measurement unit 120's position while shooting, the control device 110 calculates the coordinate of the interest object in the interior coordinate system. The optical transmitter modules 140 and 150 emit one beam individually to the ground vertically, and the optical transmitter modules 140 and 150 emits to the two sides of each interior reference point individually in order to obtain two alignment points so as to the control device 110 can obtain the position and the movement direction of the interior mobile mapping system currently. The interior mobile mapping system can align the position of the reference points and recognize movement direction easily when the interior mobile mapping system returns to the position of the two reference points. Therefore, the accuracy and efficiency of the mapping operation are improved.

The system and method for interior mobile mapping of the present invention is adapted for updating an interior layout of an inspected area. Within a restricted time, the inertial measurement unit 120 can keep in a high-accuracy situation. Through a zero velocity update mechanism of the inertial measurement unit 120, at least one interior reference points are established in the inspected area quickly, discretely, and uniformly within the restricted time. For example, if the inertial measurement unit 120 can keep in a high-accuracy situation within 5 minutes, N interior reference points must be established in the inspected within 5 minutes. The N is a positive integer and can be adjusted by requirements of the user. After establishing the interior reference points and checking their coordinates, the interior mobile mapping system of the present invention moves from one of the interior reference points and take pictures for the interest objects through the digital camera module 130. Next, the control device 110 uses the captured pictures and the current shooting location when the digital camera module 130 is operated in order to analyze the coordinate of the interest objects.

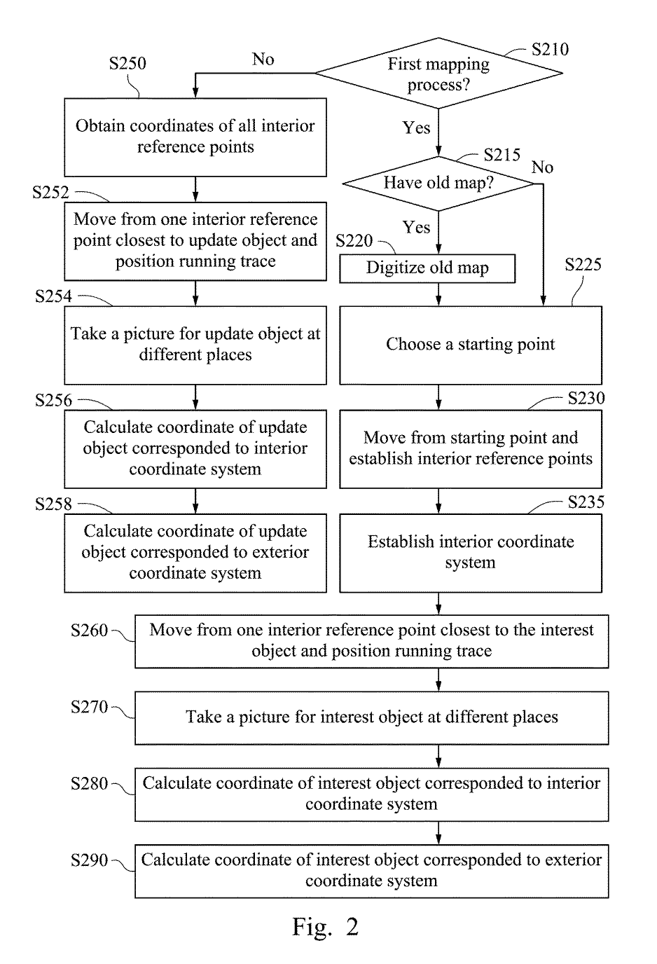

The following explains the detailed operating procedures with a flowchart. FIG. 2 is a flowchart of the interior mobile mapping method according to the first embodiment of the present invention. Referring FIG. 1 and FIG. 2, firstly, whether the mapping process of the inspected area operated at first time or not is determined (Step S210). If the determination of the Step 210 is yes, and then to determine whether there is any old map corresponded to the inspected area (Step S215). If the determination of the Step 215 is no that represents there are no old maps corresponded to the inspected area. Next, a starting point is chosen at exterior area, and the coordinate of the starting point corresponded the exterior coordinate system is obtained (Step S225). Moving from the starting point, the control device 110 uses inertial measurement unit 120 to establish at least two interior reference points (Step 230). When the inertial measurement unit 120 establishes at least two interior reference points, the optical transmitter modules 140 and 150 emit one beam individually to the two sides of each interior reference point in order to obtain two alignment points. After that, the control device 110 uses the at least two interior reference points which have respective coordinate corresponded the exterior coordinate system to establish the interior coordinate system (Step S235). Since the interior coordinate system is established by the at least two interior reference points, each of the at least two interior reference points has a coordinate corresponded to the interior coordinate system respectively.

However, if the determination of the Step 215 is yes, then the old map is digitized (Step S220). Next, a starting point is chosen at exterior area, and the coordinate of the starting point corresponded the exterior coordinate system is obtained (Step S225). Moving from the starting point, the control device 110 uses inertial measurement unit 120 to establish at least two interior reference points (Step 230). After that, the control device 110 uses the at least two interior reference points which have respective coordinate corresponded the exterior coordinate system to establish the interior coordinate system (Step S235), then, the control device 110 transfers coordinate parameters of the old map to new coordinates which are in accordance with the interior coordinate system.

For example, if the exterior coordinate system is Global Positioning system (GPS), the starting point can be chosen from the position nearby the entrance of the inspected area, so as to receive GPS signals and extend interior reference points from the starting point easily. The starting point has a coordinate corresponded to the GPS and also has a coordinate corresponded to the interior coordinate system. The at least two interior reference points are established through the inertial measurement unit 120 and extended from the starting point, so each of the at least two reference points also has a coordinate corresponded to the GPS respectively.

Next, Moving from one interior reference point which is the closest interior reference point corresponding to the interest object, the running trace of the inertial measurement unit 120 in the inspected area is feedback positioned by the control device 110 according to the coordinate of each interior reference point (Step S260). While Moving from one interior reference point that is the closest interior reference point corresponded to the interest object, the optical transmitter modules 140 and 150 emit one beam individually to align the two alignment points, so as to check a position and an orientation of the interior mobile mapping system. The control device 110 uses the digital camera module 130 to take one picture for the interest object at more than two different places individually (Step S270). The coordinate of the interest object corresponded to the interior coordinate system is calculated according to the respective position of the interest object in the more than two pictures and the coordinate of the more than two shooting locations of the digital camera module 130 corresponded to the interior coordinate system (Step S280). Finally, the control device 110 calculates the coordinate of the interest object corresponded to the exterior coordinate system according to the coordinate of the interest object corresponded to the interior coordinate system and the coordinate of the interior reference point closest to the interest object corresponded to the interior coordinate system (Step S290), so as to merge the interest object's three-dimension coordinate corresponded to interior coordinate system with the interest object's three-dimension coordinate corresponded to the exterior coordinate system seamlessly.

However, the above description is focus on that the interior reference points are established at first time then the interior reference points are used to measure the interest object. The following description explains an update mode that is not the first mapping process, and the update mode is used for updating the interior layout of the inspected area. Firstly, if the determination of the Step S210 IS no that represents the interior reference points have been established. Next, the control device 110 obtains the respective coordinate of all the interior reference points corresponded to the interior coordinate system (Step S250). Moving from one interior reference point which is the closest interior reference point corresponding to the update object, the running trace of the inertial measurement unit 120 in the inspected area is feedback positioned by the control device 110 according to the coordinate of each interior reference point (Step S252). While moving from one interior reference point that is the closest interior reference point corresponded to the update object, the optical transmitter modules 140 and 150 emit one beam individually to align the two alignment points, so as to check a position and an orientation of the interior mobile mapping system. Next, The control device 110 uses the digital camera module 130 to take one picture for the update object at more than two different places individually (Step S254). The coordinate of the update object corresponded to the interior coordinate system is calculated according to the respective position of the update object in the more than two pictures and the coordinate of the more than two shooting locations of the digital camera module 130 corresponded to the interior coordinate system (Step S256). Finally, the control device 110 calculates the coordinate of the update object corresponded to the exterior coordinate system according to the coordinate of the update object corresponded to the interior coordinate system and the coordinate of the interior reference point closest to the update object corresponded to the interior coordinate system (Step S258), so as to merge the update object's three-dimension coordinate corresponded to interior coordinate system with the update object's three-dimension coordinate corresponded to the exterior coordinate system seamlessly.

The interior mobile mapping system illustrated as FIG. 1 has another embodiment that is adapted for produce an interior layout of the inspected area. A running trace of the interior mobile mapping system is positioned according to the acceleration of the interior mobile mapping system by the inertial measurement unit 120. The digital camera module 130 is used to shoot the peripheral image of the interior mobile mapping system. The control device is coupled to the inertial measurement unit 120 and the digital camera module 130, and the control device 110 is used to calculate a coordinate of each point on the running trace according to an initial coordinate of an initial position. The control device 110 calculates the coordinate of a real object according to the pictures which are focus on the real object and captured by the digital camera module 130 at more than two shooting location on the running trace and coordinates of the more than two shooting locations, so as to update the interior layout. The two optical transmitter modules 140, 150 are configured on the interior mobile mapping system and individually emit a beam to the ground vertically at an operational state in order to align at least two alignment points, so as to check a position and an orientation of the interior mobile mapping system at the initial position precisely.

The interior mobile mapping method of the present invention implemented by a mobile image system in another embodiment. The mobile image system includes an inertial measurement unit, an image capture unit and a control device, and the mobile image system is adapted for producing an interior layout of an interior inspected area. The interior inspected area has an update object. The interior mobile mapping method comprises the following steps: firstly, obtaining coordinates of at least two interior reference points corresponded to an exterior coordinate system, and the at least two interior reference points are established by the inertial measurement unit. Next, the mobile image system moves from the interior reference point which is closest to the update object, and the running trace of the mobile image system in the interior inspected area is feedback positioned according to the coordinates of each interior reference point by the inertial measurement unit. Next, the image capture unit takes one picture for the update object at more than two different places individually. Finally, the control device calculates a coordinate of the update object according to the respective position of the update object in the more than two pictures and coordinates of the more than two shooting locations, so as to update the interior layout.

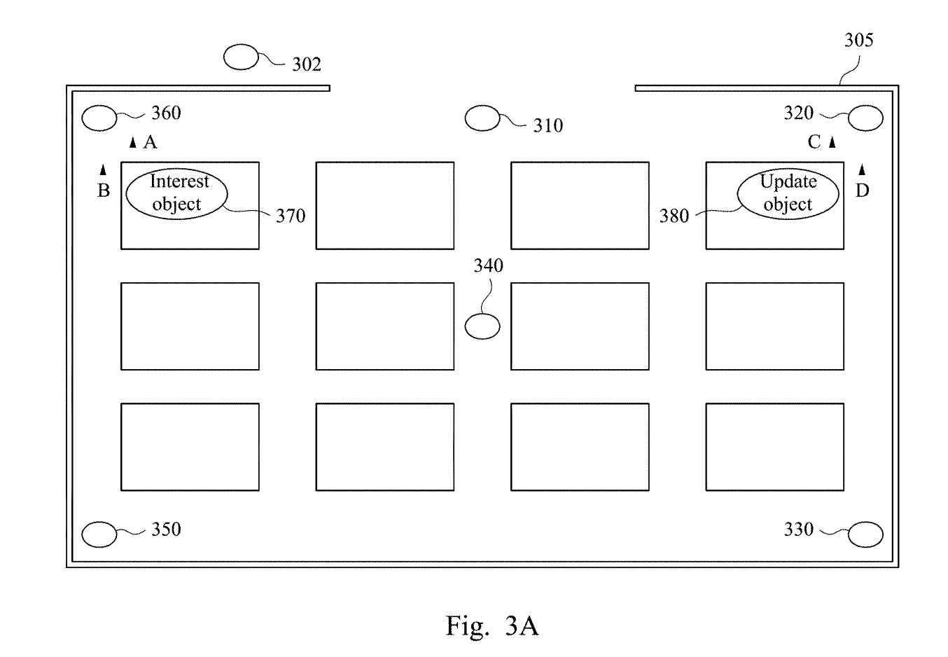

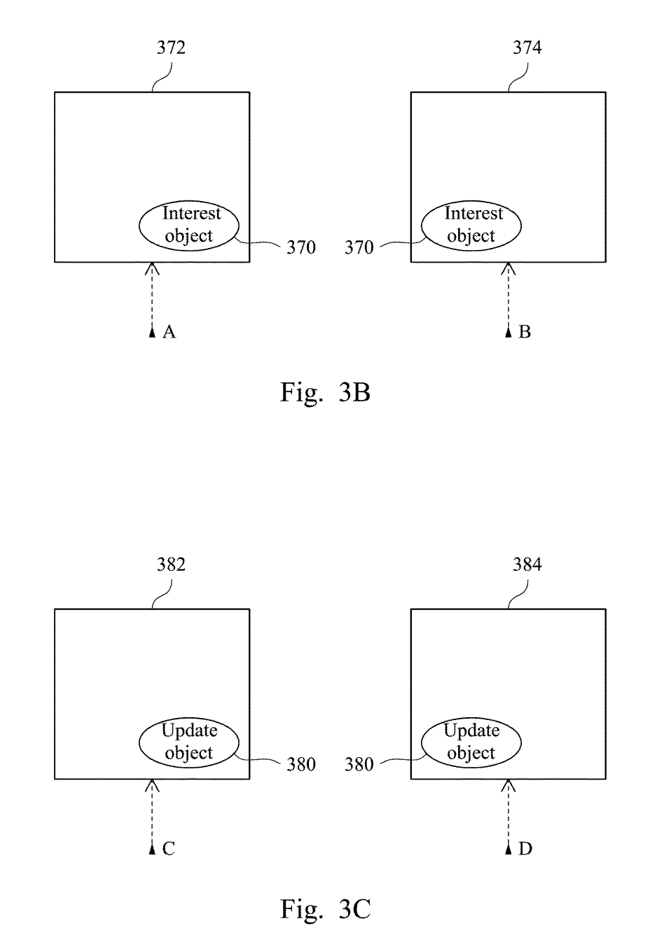

FIG. 3A, FIG. 3B and FIG. 3C are operation schematic diagrams of the interior mobile mapping method according to the first embodiment of the present invention. The operating process of the present invention can be explained with the following description and the FIGS. 3A, 3B and 3C. In the present embodiment, referring to FIG. 3A, in the peripheral position of the inspected area 305, a starting point 302 close to an entrance of the inspected area 305 is chosen. In addition, there are interior reference points 310, 320, 330, 340, 350, and 360 in the inspected area 305.

As illustrated in FIG. 3A, the interior reference point 360 is the closest interior reference point corresponding to the interest object 370. Moving from the interior reference point 360 which is the closest interior reference point corresponding to the interest object 370, the running trace of the inertial measurement unit 120 in the inspected area 305 is feedback positioned according to the coordinates of each interior reference point. As illustrated in FIG. 3A, the interior mobile mapping system of the present invention uses the digital camera module 130 to take one picture for the interest object 370 at two different places A and B individually. Next, as illustrated in FIG. 3B, the coordinate of the interest object 370 corresponded to the interior coordinate system is calculated according to the respective position of the interest object in the picture 372 and 374 and the coordinate of the position A and B corresponded to the interior coordinate system. As illustrated in FIG. 3B, in the picture 372 took at position A, the interest object 370 is located in the lower right corner. In the picture 374 took at position B, the interest object 370 is located in the lower left corner. Accordingly, The coordinate of the interest object 370 corresponded to the interior coordinate system can be calculated according to the respective position of the interest object in the picture 372 and 374 and the coordinate of the position A and B corresponded to the interior coordinate system. If there are other interest objects, the above process can be operated to establish the coordinate of each interest object so as to complete the overall interior layout.

In addition, there is a similar operation for an update object. As illustrated in FIG. 3A, the interior reference point 320 is the closest interior reference point corresponding to the update object 380. Moving from the interior reference point 320 which is the closest interior reference point corresponding to the update object 380, the running trace of the inertial measurement unit 120 in the inspected area 305 is feedback positioned according to the coordinates of each interior reference point. As illustrated in FIG. 3A, the interior mobile mapping system of the present invention uses the digital camera module 130 to take one picture for the update object 380 at two different places C and D individually. Next, as illustrated in FIG. 3C, the coordinate of the update object 380 corresponded to the interior coordinate system is calculated according to the respective position of the update object in the picture 382 and 384 and the coordinate of the position C and D corresponded to the interior coordinate system. As illustrated in FIG. 3C, in the picture 382 took at position C, the update object 380 is located in the lower right corner. In the picture 384 took at position D, the update object 380 is located in the lower left corner. Accordingly, the coordinate of the update object 380 corresponded to the interior coordinate system can be calculated according to the respective position of the update object in the picture 382 and 384 and the coordinate of the position C and D corresponded to the interior coordinate system. If there are other update objects, the above process can be operated to establish the coordinate of each update object so as to update the overall interior layout.

The present invention provides an interior mobile mapping system and method thereof. Since the inertial measurement unit can keep in a high-accuracy within a restricted time, the interior reference points are established uniformly within the restricted time. Next, to measure interest object or update object, the inertial measurement unit can move from the interior reference point which is closest to the interest object or update object, so as to eliminate the error which is caused by the inertial measurement unit merely uses the zero velocity update mechanism to measure the displacement. Accordingly, the interior mobile mapping system of the present invention makes each space of an inspected area has an identical accuracy and improves the updating efficiency. The interior mobile mapping system of the present invention also can incorporate an old map to operate the coordinate transform so as to have wide applications. In addition, the interior mobile mapping system uses interior reference points which have coordinates corresponded to the exterior coordinate system and coordinates corresponded to the interior coordinate system simultaneously to obtain the coordinate of the interest object or the update object corresponded the exterior coordinate system. Accordingly, the interior mobile mapping system merges the interest or update object's three-dimension coordinate corresponded to interior coordinate system with the interest or update object's three-dimension coordinate corresponded to the exterior coordinate system seamlessly.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of the present invention provided they fall within the scope of the following claims.

What is claimed is:

1. An interior mobile mapping system is adapted for producing or updating an interior layout of an inspected area, comprising:
an inertial measurement unit;
a digital camera module; and
a control device coupled to the inertial measurement unit and the digital camera module, wherein the control device establishes at least two interior reference points through the inertial measurement unit and obtains the respective coordinate of the at least two interior reference points corresponded to an interior coordinate system, the control device moves from one interior reference point which is the closest interior reference point corresponding to an update object, a running trace of the inertial measurement unit in the inspected area is feedback positioned by the control device according to the coordinate of the at least one interior reference points, the control device uses the digital camera module to take one picture for the update object at more than two different places individually, the coordinate of the update object corresponded to the interior coordinate system is calculated by the control device according to the respective position of the update object in the more than two pictures and the coordinate of the more than two shooting locations corresponded to the interior coordinate system, so as to update the interior layout.

2. The interior mobile mapping system of claim 1, further comprising:
the control device calculates the coordinate of the update object corresponded to an exterior coordinate system according to the coordinate of the update object corresponded to the interior coordinate system and the coordinate of the interior reference point closest to the update object corresponded to the interior coordinate system, wherein the control device uses the at least two interior reference points which have respective coordinate corresponded the exterior coordinate system to establish the interior coordinate system.

3. The interior mobile mapping system of claim 1, further comprising:
an starting point is chosen at exterior area and the coordinate of the starting point corresponded an exterior coordinate system is obtained when a mapping process of the inspected area operated at first time and no old map corresponded to the inspected area are determined, wherein the control device moves from the starting point and uses the inertial measurement unit to establish at least two interior reference points in the inspected area, and the control device uses the at least two interior reference points which have respective coordinate corresponded the exterior coordinate system to establish the interior coordinate system.

4. The interior mobile mapping system of claim 1, further comprising:
an old map is digitized when a mapping process of the inspected area operated at first time and having the old map corresponded to the inspected area are determined, wherein an starting point is chosen at exterior area and the coordinate of the starting point corresponded an exterior coordinate system is obtained, the control device moves from the starting point and uses inertial measurement unit to establish at least two interior reference points, and the control device uses the at least two interior reference points which have respective coordinate corresponded the exterior coordinate system to establish the interior coordinate system and transfers coordinate parameters of the old map to new coordinates which are in accordance with the interior coordinate system.

5. The interior mobile mapping system of claim 3, further comprising:
the control device moves from one interior reference point which is the closest interior reference point corresponding to an interest object, wherein a running trace of the inertial measurement unit in the inspected area is feedback positioned by the control device according to the coordinate of the at least one interior reference points, the control device uses the digital camera module to take one picture for the interest object at more than two different places individually, the coordinate of the interest object corresponded to the interior coordinate system is calculated by the control device according to the respective position of the interest object in the more than two pictures and the coordinate of the more than two shooting locations corresponded to the interior coordinate system, so as to produce the interior layout, the control device calculates the coordinate of the interest object corresponded to the exterior coordinate system according to the coordinate of the interest object corresponded to the interior coordinate system and the coordinate of the interior reference point closest to the interest object corresponded to the interior coordinate system.

6. The interior mobile mapping system of claim 4, further comprising:
the control device moves from one interior reference point which is the closest interior reference point corresponding to an interest object, wherein a running trace of the inertial measurement unit in the inspected area is feedback positioned by the control device according to the coordinate of the at least one interior reference points, the control device uses the digital camera module to take one picture for the interest object at more than two different places individually, the coordinate of the interest object corresponded to the interior coordinate system is calculated by the control device according to the respective position of the interest object in the more than two pictures and the coordinate of the more than two shooting locations corresponded to the interior coordinate system, so as to produce the interior layout, the control device calculates the coordinate of the interest object corresponded to the exterior coordinate system according to the coordinate of the interest object corresponded to the interior coordinate system and the coordinate of the interior reference point closest to the interest object corresponded to the interior coordinate system.

7. The interior mobile mapping system of claim 1, further comprising:
two optical transmitter modules are coupled to the control device and emit one beam individually to the ground vertically, wherein the two optical transmitter modules emit one beam individually to the two sides of each interior reference point in order to obtain two alignment points when the inertial measurement unit establishes at least two interior reference points, the two optical transmitter modules emit one beam individually to align the two alignment points when the control device moves from one interior reference point that is the closest interior reference point corresponded to the interest object, so as to check a position and an orientation of the interior mobile mapping system.

8. An interior mobile mapping method is adapted for producing or updating an interior layout of an inspected area, comprising:
obtaining the respective coordinate of the at least two interior reference points corresponded to an interior coordinate system, wherein the at least two interior reference are established by an inertial measurement unit;
moving from one interior reference point which is the closest interior reference point corresponding to an update object, wherein a running trace of the inertial measurement unit in the inspected area is feedback positioned according to the coordinate of the at least one interior reference points;
taking one picture for the update object at more than two different places individually; and
calculating the coordinate of the update object corresponded to the interior coordinate system according to the respective position of the update object in the more than two pictures and the coordinate of the more than two shooting locations corresponded to the interior coordinate system, so as to update the interior layout.

9. The interior mobile mapping method of claim 8, further comprising:
calculating the coordinate of the update object corresponded to an exterior coordinate system according to the coordinate of the update object corresponded to the interior coordinate system and the coordinate of the interior reference point closest to the update object corresponded to the interior coordinate system, wherein the interior coordinate system is established by the at least two interior reference points which have respective coordinate corresponded the exterior coordinate system.

10. The interior mobile mapping method of claim 8, further comprising:
choosing an starting point at exterior area and obtaining the coordinate of the starting point corresponded an exterior coordinate system when a mapping process of the inspected area operated at first time and no old map corresponded to the inspected area are determined;
moving from the starting point and using the inertial measurement unit to establish at least two interior reference points in the inspected area; and
using the at least two interior reference points which have respective coordinate corresponded the exterior coordinate system to establish the interior coordinate system.

11. The interior mobile mapping method of claim 8, further comprising:
digitizing an old map when a mapping process of the inspected area operated at first time and having the old map corresponded to the inspected area are determined;
choosing an starting point at exterior area and obtaining the coordinate of the starting point corresponded an exterior coordinate system;
moving from the starting point and using the inertial measurement unit to establish at least two interior reference points in the inspected area; and
using the at least two interior reference points which have respective coordinate corresponded the exterior coordinate system to establish the interior coordinate system and transferring coordinate parameters of the old map to new coordinates which are in accordance with the interior coordinate system.

12. The interior mobile mapping method of claim 10, further comprising:
moving from one interior reference point which is the closest interior reference point corresponding to an interest object, wherein a running trace of the inertial measurement unit in the inspected area is feedback positioned according to the coordinate of the at least one interior reference points;
taking one picture for the interest object at more than two different places individually;
calculating the coordinate of the interest object corresponded to the interior coordinate system according to the respective position of the interest object in the more than two pictures and the coordinate of the more than two shooting locations corresponded to the interior coordinate system; and
calculating the coordinate of the interest object corresponded to the exterior coordinate system according to the coordinate of the interest object corresponded to the interior coordinate system and the coordinate of the interior reference point closest to the interest object corresponded to the interior coordinate system.

13. The interior mobile mapping method of claim 11, further comprising:
moving from one interior reference point which is the closest interior reference point corresponding to an interest object, wherein a running trace of the inertial measurement unit in the inspected area is feedback positioned according to the coordinate of the at least one interior reference points;
taking one picture for the interest object at more than two different places individually;
calculating the coordinate of the interest object corresponded to the interior coordinate system according to the respective position of the interest object in the more than two pictures and the coordinate of the more than two shooting locations corresponded to the interior coordinate system; and
calculating the coordinate of the interest object corresponded to the exterior coordinate system according to the coordinate of the interest object corresponded to the interior coordinate system and the coordinate of the interior reference point closest to the interest object corresponded to the interior coordinate system.

14. The interior mobile mapping method of claim 8, further comprising:
using two optical transmitter modules to emit one beam individually to the two sides of each interior reference point in order to obtain two alignment points when the inertial measurement unit establishes at least two interior reference points; and
using the two optical transmitter modules to emit one beam individually to align the two alignment points when the control device moves from one interior reference point that is the closest interior reference point corresponded to the interest object, so as to check a position and an orientation of the interior mobile mapping system.

15. An interior mobile mapping method, comprising:
implementing by a mobile image system, wherein the mobile image system includes an inertial measurement unit, an image capture unit and a control device, the mobile image system is adapted for producing an interior layout of an interior inspected area, the interior inspected area has an update object, the interior mobile mapping method comprises the following steps:
(A) obtaining coordinates of at least two interior reference points corresponded to an exterior coordinate system, wherein the at least two interior reference points are established by the inertial measurement unit;
(B) moving from the interior reference point which is closest to the update object, and a running trace of the mobile image system in the interior inspected area is feedback positioned according to the coordinates of each interior reference point by the inertial measurement unit;
(C) taking one picture for the update object at more than two different places individually through the image capture unit; and
(D) calculating a coordinate of the update object according to the respective position of the update object in the more than two pictures and coordinates of the more than two shooting locations, so as to update the interior layout.

16. An interior mobile mapping system is adapted for producing an interior layout of an inspected area, comprising:
an inertial measurement unit used to position a running trace of the interior mobile mapping system according to an acceleration of the interior mobile mapping system;
a digital camera module used to shoot a peripheral image of the interior mobile mapping system;
a control device coupled to the inertial measurement unit and the digital camera module, wherein the control device is used to calculate a coordinate of each point on the running trace according to an initial coordinate of an initial position, the control device calculates the coordinate of a real object according to the pictures which are focus on the real object and captured by the digital camera module at more than two shooting location on the running trace and coordinates of the more than two shooting locations, so as to update the interior layout; and
at least two optical transmitter modules configured on the interior mobile mapping system and individually emit a beam to the ground vertically at an operational state in order to align at least two alignment points, so as to check a position and an orientation of the interior mobile mapping system at the initial position precisely.
